(19) United States
(12) Patent Application Publication
(10) Pub. No.: US 2025/0260529 A1
(43) Pub. Date: Aug. 14, 2025

(54) Computer Implemented Method of Generating a Pseudo Random Sequence (PRS)

(71) Applicant: Hong Kong Applied Science And Technology Research Institute Co., Ltd., Shatin, N.T. (HK)

(72) Inventors: Ying Lun Tsui, Tai Po, NT (HK); Liqiong Liu, Tai Po, NT (HK); Yi Hang Sim, North Point (HK); Ki Hang Chung, Kowloon (HK); Eddy Chiu, Kowloon (HK)

(21) Appl. No.: 18/436,342

(22) Filed: Feb. 8, 2024

(51) Int. Cl. H04L 5/00

(52) U.S. Cl. CPC H04L 5/0048

(57) ABSTRACT

A computer implemented method of generating a pseudo random sequence (PRS). The method comprises sub-dividing PRS generation operations into a plurality of PRS partitions. For each PRS partition, a PRS generation register value is determined based on an initial PRS value and a pre-computed PRS generation register advancement value. For each partition, the determined PRS generation register value is used to generate a PRS of an arbitrary or a predetermined length. The method includes transmitting the generated PRS to a computing module, device or system to perform a data processing function.

### FIELD OF THE INVENTION

The invention relates to a computer implemented method of generating a pseudo random sequence (PRS). The invention relates particularly, but not exclusively, to a method of generating a PRS in a communications network such as, but not limited to, a fifth generation (5G) New Radio (NR) communications network.

### BACKGROUND OF THE INVENTION

In a 5G communications network, pseudo random sequences (PRSs) are typically generated within the base station (also known as the gNodeB or gNB). The PRSs are used for various purposes, including synchronization, channel estimation, data scrambling, and spreading of user data. The gNodeB generates PRSs using mathematical algorithms, typically based on Linear Feedback Shift Registers (LFSRs) or other similar techniques. These algorithms are designed to produce sequences that exhibit pseudo random properties, meaning they appear random but are actually deterministic and can be reproduced.

Once generated, the PRSs are used in different parts of the 5G communications network. For example, in the initial synchronization phase, the gNodeB transmits known sequences called primary synchronization signals (PSS) and secondary synchronization signals (SSS) that help the user equipment (UE) synchronize with the communications network. These synchronization signals are based on specific PRSs. Furthermore, PRSs are used in the physical layer for spreading, scrambling, and interference mitigation. Spreading codes are applied to the user data to increase the bandwidth and provide multiple access in the uplink and downlink. Scrambling codes are used to differentiate between different users in the system and to minimize or mitigate interference. Overall, PRSs play an important role in various aspects of a 5G communications network.

One issue which arises in the generation of PRSs is that a typical step-by-step process for generating PRSs is computationally intensive and often too slow for real-time processing environments such as, for example, mobile communications networks. In a case where PRS generation uses look-up-tables (LUTs) with pre-computed PRSs, this requires considerable memory resources for storing long PRSs for different applications having different application specific initial PRS values.

What is desired is a method to optimize or at least improve PRS generation, especially for real-time environments as found in mobile communications networks.

### OBJECTS OF THE INVENTION

An object of the invention is to mitigate or obviate to some degree one or more problems associated with known methods of generating PRSs, especially for generating PRSs in a communications network.

The above object is met by the combination of features of the main claims; the sub-claims disclose further advantageous embodiments of the invention.

Another object of the invention is to provide a novel computing device configured with an improved method for generating PRSs.

Another object of the invention is to provide a novel communications network device for a mobile communications network with an improved method for generating PRSs.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a computer implemented method of generating a PRS. The method comprises sub-dividing PRS generation operations into a plurality of PRS partitions. For each PRS partition, determining a PRS generation register value based on an initial PRS value and a pre-computed PRS generation register advancement value. Also, for each partition, using the determined PRS generation register value to generate a PRS of an arbitrary or a predetermined length. Then, transmitting said generated PRS to a computing module, device, or system to perform a data processing function. The data processing function may comprise a specific application. This may include, prior to transmitting said generated PRS to the computing module, device, or system, splitting a PRS generated for a PRS partition and/or concatenating two or more PRSs generated for two or more PRS partitions to form the generated (final) PRS to be transmitted to the computing module, device or system.

In a second main aspect, the invention provides a computing module, device, or system comprising: a memory storing machine-readable instructions; and a processor for executing the machine-readable instructions such that, when the processor executes the machine-readable instructions, it configures the computing module, device, or system to implement the method of the first aspect of the invention.

Preferably, the computing module, device, or system comprises a communication network device.

Preferably, the communications network device comprises a gNodeB.

In a third main aspect, the invention provides a non-transitory computer readable medium comprising machine-readable instructions which, when executed by a processor of a computing module, device, or system, causes the computing module, device, or system to implement the method of the first aspect of the invention.

The summary of the invention does not necessarily disclose all the features essential for defining the invention; the invention may reside in a sub-combination of the disclosed features.

The forgoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic diagram illustrating a method of scrambling data in a mobile communications network to differentiate between different UEs;

FIG. 2 is a schematic diagram illustrating a method of mitigating interference between transmissions from gNodeBs to a UE in a mobile communications network;

FIG. 3 illustrates a known method of scrambling data in a mobile communications network;

FIG. 4 illustrates a known method of data protection and interference mitigation in a mobile communications network;

FIG. 5 illustrates PRS generation using bitwise operations for an M sequence PRS;

FIG. 6 is a flow diagram of a known step-by-step method of generating PRSs in a mobile communications network;

FIG. 7 is a block schematic diagram of an improved communication network device or network node in accordance with the invention;

FIG. 8 is a schematic diagram of logic modules for implementing a flexible PRS generation method in accordance with the invention;

FIG. 9 illustrates a LUT comprising PRS generation advancement values in accordance with the invention; and

FIG. 10 is a flow diagram of a progressive PRS generation register value calculation method in accordance with the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the drawings may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

In computer architecture, a PRS generation register value refers to the current state or content of the register used to generate a PRS. A PRS is a deterministic sequence of numbers that appears to be random. It is generated using an algorithmic process that starts with an initial value (seed) and applies a series of mathematical operations to produce subsequent values. The PRS generation register value represents the current state of the algorithm and is used as the starting point for generating the next pseudo random number in the sequence. Each time a new number is generated, the PRS generation register value is updated. The specific details of the PRS generation register value, including its size, format, and update mechanism, depend on the particular algorithm or generator being used. Different algorithms, such as LFSRs or cryptographic algorithms like the Advanced Encryption Standard (AES), may have different register structures and update rules for generating PRSs. The PRS generation register value alone does not define the complete PRS. The seed value and the algorithm used are important components in determining the entire sequence.

As indicated above, not all PRSs are generated using LFSRs. LFSRs are a specific type of shift register that can be used to generate PRSs. LFSRs are commonly used in applications where a simple, efficient, and deterministic pseudo random number generator is required. They are often used in hardware implementations due to their simplicity and low resource requirements. LFSRs are based on a shift register and a feedback function that determines the next bit in the sequence based on the current state of the register. The output sequence appears random but is actually deterministic and repeats after a certain number of iterations, known as the period. However, there are other algorithms and methods used for generating PRSs, such as, for example, linear congruential generators (LCGs), cryptographic algorithms like AES, and Mersenne Twister. These algorithms are designed to have good statistical properties and longer periods than LFSRs, making them suitable for a wide range of applications, including simulations, cryptography, and statistical analysis.

It will be understood that the present invention as hereinafter described can be applied to the generation of PRSs using different algorithms, different update rules, and/or different register structures.

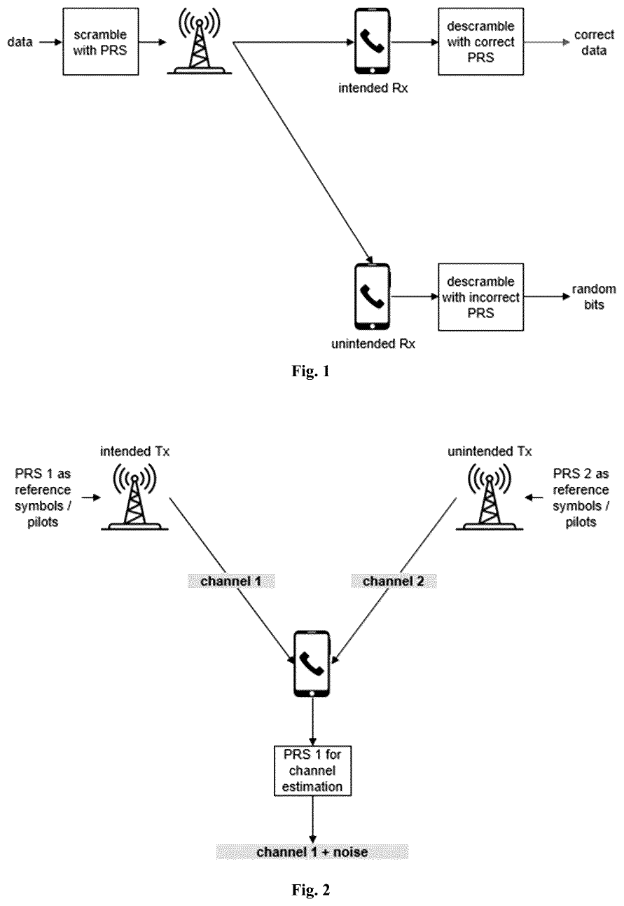

Referring to the drawings, FIG. 1 illustrates a method of scrambling data in a mobile communications network to differentiate between different UEs. Only the UE with the correct PRS will be able to descramble the scrambled data.

FIG. 2 illustrates a method of mitigating interference between transmissions received at a UE from different gNodeBs. The UE mitigates interference by using the correct PRS for an intended transmission thereby mitigating any interference from an unintended transmission.

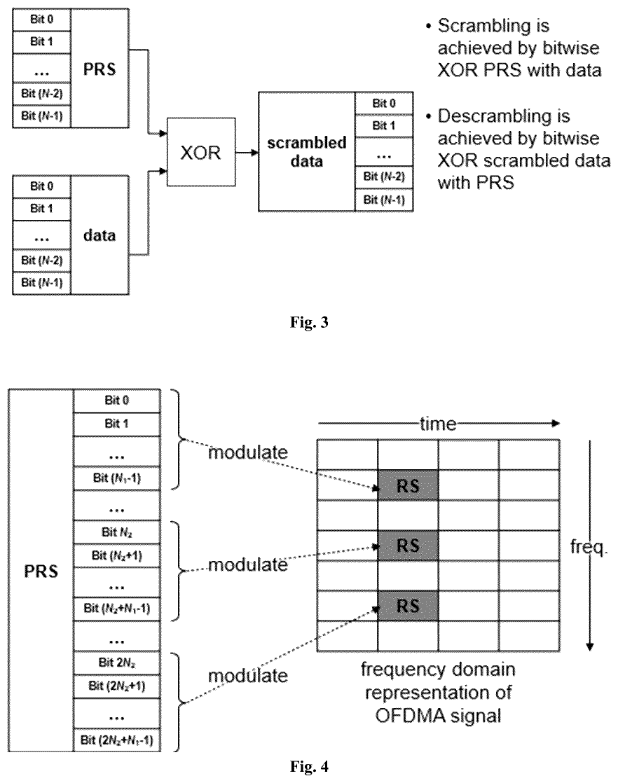

In FIG. 3, scrambling of data at, for example, a gNodeB, is achieved by bitwise XOR of the PRS with data whilst descrambling of data at, for example, a UE, is achieved by bitwise XOR of the scrambled data with the PRS.

The 5G communications network supports high data rates and the computational load for generating PRSs scales with the amount of data. Data scrambling/descrambling is computationally intensive. It would be beneficial to execute scrambling/descrambling of data by means of parallel processing. It would also therefore be beneficial to implement generation of PRSs by means of parallel processing.

In FIG. 4, reference symbols are obtained by modulating PRS partitions, but it is computationally inefficient to generate PRS bits that are unused.

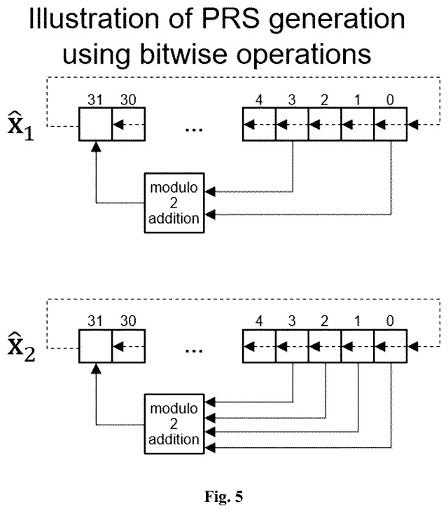

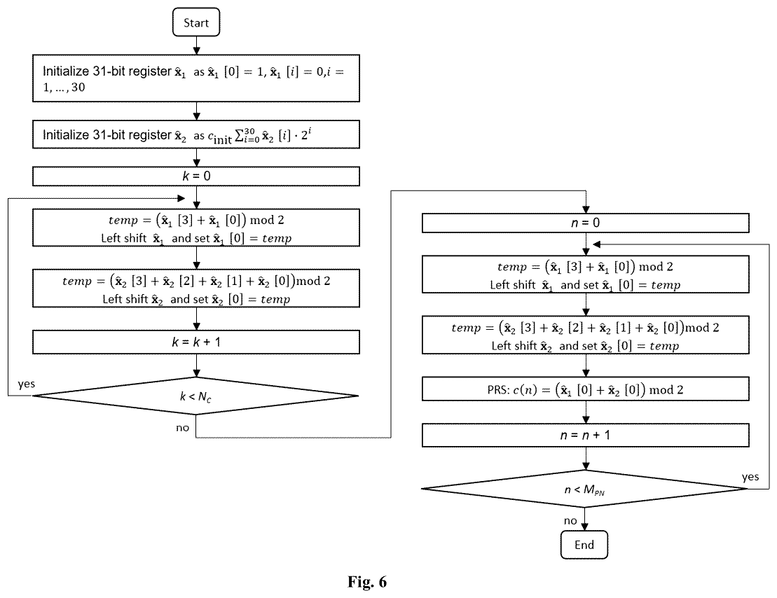

FIG. 5 illustrates PRS generation using bitwise operations for an M sequence PRS and FIG. 6 provides a flow diagram of a known step-by-step method of generating PRSs in a mobile communications network.

In a 5G communications network, the M sequence PRS is generated using the Galois LFSR method. The M sequence PRS is used, for example, for scrambling and spreading signals in the uplink and downlink transmissions. The polynomial used for generating the M sequence is typically a primitive polynomial over a Galois field. The M sequence has a balanced number of 1s and 0s. M sequences of length 31 are commonly used in 5G for synchronization and channel estimation purposes. These sequences have good autocorrelation and cross-correlation properties, which make them suitable for synchronization and channel estimation in the presence of multipath fading.

The specific steps involved in generating a 5G M series PRS normally comprise:

### Initialization:

setting the initial state of the LFSR. The initial state is typically a non-zero value; and
determining the feedback taps of the LFSR. These taps are specific bits in the LFSR sequence that are used to generate the next bit.

### Bit Generation:

generate each bit of the PRS sequence using the LFSR. The LFSR operates by shifting the current state and calculating the next bit based on the feedback taps;
the feedback taps are used to determine the XOR combination of specific bits in the current state. The result of the XOR operation becomes the next bit in the PRS sequence; and
Repeat this process for the desired length of the PRS sequence.

### Truncation:

the generated PRS sequence might be longer than the desired length. In this case, truncate the sequence to the desired length.

### Mapping:

map the generated PRS sequence onto the available resources based on the specific 5G configuration; and
the mapping process determines how the PRS sequence is distributed across different symbols, subcarriers, and resource blocks in the frequency and time domains.

### Transmission:

the PRS sequence is then transmitted over the air interface; and
the receiving end, such as a UE, can use the known PRS sequence to perform tasks like synchronization, channel estimation, and signal demodulation.

The exact details of the LFSR initialization and feedback taps are specified in the 5G standard, defined by the 3rd Generation Partnership Project (3GPP). The specific parameters used for generating the M series PRS may vary depending on the 5G release and the configuration of the system. The latest release is 3GPP TS 38.211 V18.1.0 (2023-12) entitled “3rd Generation Partnership Project; Technical Specification Group Radio Access Network; NR; Physical channels and modulation (Release 18)”.

The generic PRSs are defined by a length-31 Gold sequence. The output sequence c(n) of length M_{PN}, where n=0, 1, . . . . M_{PN-1}, is defined by:

$$c ( n ) = ( {x}_{1} ( n + {N}_{c} ) + {x}_{2} ( n + {N}_{c} ) ) mod 2 ;$$

a first long-term sequence: x₁(n+31)=(x₁(n+3)+x₁(n))mod 2; and
a second long-term sequence: x₂(n+31)=(x₂(n+3)+x₂(n+2)+x₂(n+1)+x₂(n))mod 2;
where N_{C}=1600;
the first long-term m-sequence x₁(n) is initialized with x₁(0)=1, x₁(n)=0), n=, 1, 2, . . . , 30; and
the second long-term m-sequence x₂(n) is initialized with

$${c}_{init} = {\sum }_{i = 0}^{30} {x}_{2} ( i ) \cdot {2}^{i}$$

where the value of cᵢₙᵢₜ depends on the application of the sequence.

For example, for scrambling of data in the physical downlink data channel (PDSCH), the initialization value of the second long-term m-sequence, x₂(n), is cᵢₙᵢₜ=n_{RNTI}·2¹⁵+q·2¹⁴+n_{ID}. For the physical uplink control channel (PUCCH) reference symbols, the initialization value of the second long-term m-sequence, x₂(n), is cᵢₙᵢₜ=(2¹⁷(N_{symb}^{slot}n_{s,f}^{μ}+l+1)(2N_{ID}⁰+1)+2N_{ID}⁰)mod 2³¹, where N_{ID} is the physical cell number. For data scrambling in the physical downlink control channel (PDCCH), the initialization value of the second long-term m-sequence, x₂(n), is cᵢₙᵢₜ=N_{ID}^{cell}.

It will be recognized that the equations given above for the 5G communications network differs little from the corresponding equations for a Long-Term Evolution (LTE) communications network. Consequently, it will be understood that the method of the present invention as hereinafter described with respect to its implementation in a 5G communications network can be also implemented in an LTE communications network.

The step-by-step PRS generation process as described above is too computationally intensive and slow for real-time processing. Furthermore, exhaustive LUT-based PRS generation with pre-computed PRSs requires too much memory for storage, i.e., requiring storage of long PRSs with different PRSs for different, application-specific initial values cᵢₙᵢₜ, etc.

As will now be described, the present invention, in one embodiment, provides a partition method and parallel processing architecture for flexible PRS generation in a 5G mobile communications network or system to, among other things, enhance processing latency and memory usage. PRS generation in 5G mobile communications networks is computationally intensive and needs to support various application-specific initial values and lengths. As 5G needs to support high data rate and low latency communications, it is beneficial to optimize or at least improve processing latency of every function to fulfill total transmitter/receiver processing time limits. Furthermore, it is beneficial to optimize or at least improve memory usage of every function to reduce hardware cost and power consumption. This can be achieved in part by sub-dividing computationally intensive tasks and executing them in parallel. The novel PRS generation implementation of the invention can use low-level programming language (e.g., assembly language), application specific integrated circuits (ASICs) and field programmable gate arrays (FPGAs), etc.

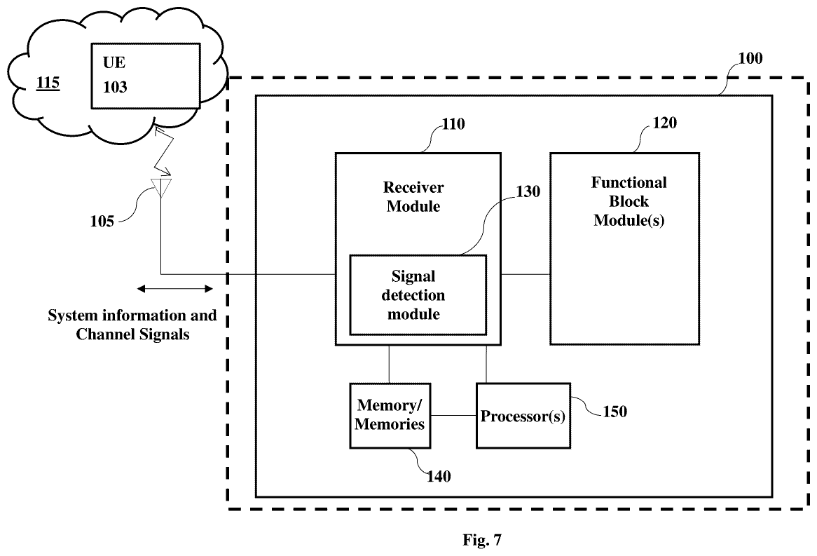

FIG. 7 shows an exemplary embodiment of an improved communications network device 100 in accordance with concepts of the present invention. In the illustrated embodiment, the communications network device 100 may comprise a communication equipment such as a gNodeB (denoted by the dashed line box in FIG. 7) communicatively connected to a UE 103 operating in a 5G NR communications system environment 115, although the improved communications network device 100 of the invention is not limited to operating in a NR 5G communications system but could comprise a radio equipment device for a 4G cellular network or any suitable cellular network. In another embodiment, the communications network device 100 may comprise a network node communicatively connected to the gNodeB (BS) 100.

The communications network device 100 may comprise a plurality of functional blocks for performing various functions thereof. For example, the communications network device 100 includes receiver module 110 providing received signal processing and configured to provide received signals and/or information extracted therefrom to functional block module(s) 120 such as may comprise various data sink, control element(s), user interface(s), etc. Although receiver module 110 is described as providing received signal processing, it will be appreciated that this functional block may be implemented as a transceiver providing both transmitted and received signal processing. Irrespective of the particular configuration of receiver 110, embodiments include signal detection module 130 disposed in association with the receiver module 110 for facilitating accurate processing and/or decoding of received information and channel signals in accordance with the invention. Information and channel signals may be transmitted/received via an antenna module 105.

Although the signal detection module 130 is shown as being deployed as part of the receiver module 110 (e.g., comprising a portion of the radio equipment module control and logic circuits), there is no limitation to such a deployment configuration according to the concepts of the invention. For example, the signal detection module 130 may be deployed as a functional block of communications network device 100 that is distinct from, but connected to, receiver module 110. The signal detection module 130 may, for example, be implemented using logic circuits and/or executable code/machine readable instructions stored in a memory 140 of the radio equipment device 100 for execution by a processor 150 to thereby perform functions as described herein. For example, the executable code/machine readable instructions may be stored in one or more memories 140 (e.g., random access memory (RAM), read only memory (ROM), flash memory, magnetic memory, optical memory or the like) suitable for storing one or more instruction sets (e.g., application software, firmware, operating system, applets, and/or the like), data (e.g., configuration parameters, operating parameters and/or thresholds, collected data, processed data, and/or the like), etc. The one or more memories 140 may comprise processor-readable memories for use with respect to one or more processors 150 operable to execute code segments of signal detection module 130 and/or utilize data provided thereby to perform functions of the signal detection module 130 as described herein. Additionally, or alternatively, the signal detection module 130 may comprise one or more special purpose processors, e.g., ASIC, FPGA, graphics processing unit (GPU), and/or the like configured to perform functions of the signal detection module 130 as described herein.

In one embodiment of the invention, the signal detection module 130 of the communications network device 100 performs the improved method of PRS generation.

Whilst the communications network device 100 of FIG. 7 is described with respect to a gNodeB 100, it could comprise any node in a mobile wireless communications system configured to implement the improved method of the invention.

The communications network device 100 is configured to generate a PRS by sub-dividing the PRS generation operations into a plurality of PRS partitions. Then, for each PRS partition, determining a PRS generation register value based on an initial PRS value and a pre-computed PRS generation register advancement value. This is followed by, for each partition, using the determined PRS generation register value to generate a PRS of an arbitrary or a predetermined length. The generated PRS is then transmitted to another communications network device such as the UE 103 to implement a specific application.

Sub-dividing PRS generation operations into partitions and running them sequentially or simultaneously across multiple parallel processes can be beneficial in terms of performance and resource utilization.

Partitioning can be achieved by dividing the desired PRS sequence length into smaller partitions. The size of each partition depends on factors such as system requirements, available computational resources, and the desired parallelization level. For example, to generate a PRS of an arbitrary or defined length, it can be divided into P partitions of length Mₚ. To run the PRS generation in parallel across multiple processes, each partition is then assigned to a separate process. Each process will generate its assigned partition independently. Then, configure each PRS generator instance in the processes to generate its assigned partition. This involves setting up the shift register size, register advancement values (tap positions), and initial state for each partition. For sequential processing, each partition is processed one after the other. This involves, generating the first partition, and once completed, moving on to the next one until all partitions are generated. Once all the partitions are generated, they may be combined to form the complete PRS by concatenating the partitions in the correct order to obtain the final PRS. Additionally or alternatively, a PRS generated for a partition may be further partitioned to provide a final PRS. In some embodiments, one or more of the processed partitions are further partitioned and then two or more of the further partitions are concatenated to provide the final PRS.

To determine the PRS generation register value for each partition, it is necessary to consider the initial value and register advancement values. To determine a register value for each PRS partition, initialize the register by starting with an initial register value for each partition. The initial value may be any binary sequence of the same length as the partition size. This value determines the starting state of the shift register. Then, apply the register advancement value from an LUT of pre-computed register advancement values to generate the subsequent register values. For a K-bit register and a specific step to advance, each bit has a corresponding K-bit advancement value in the LUT. When advancing, the register values are calculated by XORing the K-bit register advancement values. Whether the register advancement value is applied for XOR depends on the corresponding bit of the current register. This procedure is repeated and the register values iteratively updated.

The final register value obtained after iterating through the partition size is the PRS generation register value for that specific partition. This is repeated for each partition, using the initial value and advancement value specific to that partition. This process determines the PRS generation register value for each partition based on the given initial value and respective LUT advancement value. The final PRS can be generated from one or more of the stored PRSs for the various partitions through further partitioning of one of the stored PRSs for the various partitions and/or through concatenation of two or more of the stored PRSs for the various partitions. The final PRS can be generated in a partitioned manner while maintaining the desired properties across the entire sequence. The final PRS can then be transmitted over the air interface between, for example, the gNodeB 100 and the UE 103.

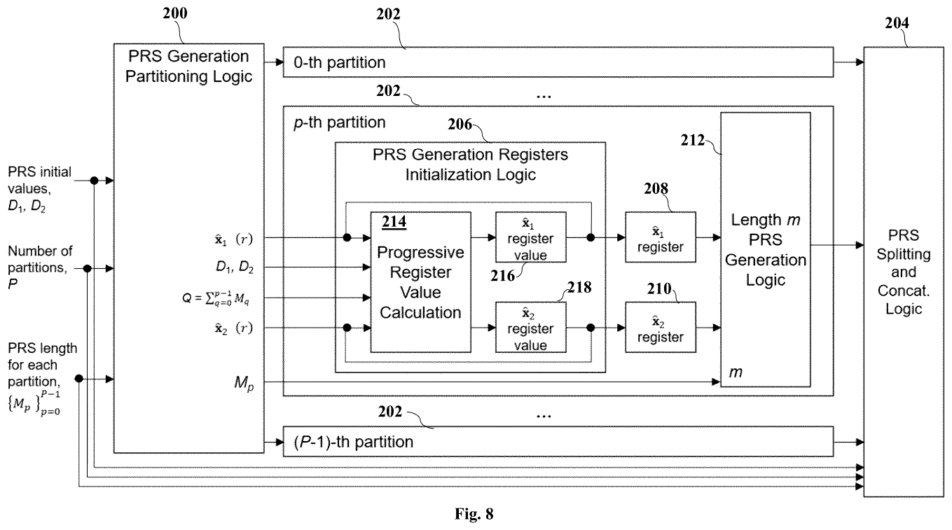

Referring to FIG. 8 which provides a schematic diagram of logic modules for implementing the flexible PRS generation method in accordance with the invention. These logic modules may be implemented in the signal detection module 130 of the communications network device 100 of FIG. 7.

The logic modules comprise a PRS generation and partitioning logic module 200, a respective partition processing module 202 for each of the 0-th to (P−1)-th partitions, and a PRS splitting and concatenation logic module 204. Each of the respective partition processing modules 202 comprises a PRS generation register initialization logic module 206, first and second register modules 208, 210 and PRS generation logic module 212. Each PRS generation register initialization logic module 206 comprises a progressive register value calculation module 214 and first and second register value modules 216, 218.

Inputs to the PRS generation and partitioning logic module 200 comprise PRS initial values D₁, D₂ respectively for the first long-term M sequence x₁(n) and the second long term sequence x₂(n). The PRS initial values D₁, D₂ may comprise application specific seed values. Other inputs include the number of partitions P and the PRS length of each partition {Mₚ}ₚ₌₀^{P-1}. These inputs are used by the PRS generation and partitioning logic module 200 to partition the PRS generation operations into the 0-th to (P−1)-th partitions. The PRS generation and partitioning logic module 200 allocates each of the 0-th to (P−1)-th partitions to a separate, respective partition processing module 202. The PRS generation and partitioning logic module 200 outputs to the PRS generation register initialization logic module 206 of each partition processing module 202: the initial value D₁ for PRS generation register \hat{x}₁ (0); the initial value D₂ for PRS generation register \hat{x}₂ (0); the PRS step from which to start generating this PRS partition, Q; and, if available, the PRS generation register values at the r-th PRS generation step \hat{x}₁ (r) and \hat{x}₂ (r), where 0<r<Q. More specifically, these inputs are provided to the progressive register value calculation module 214 of the PRS generation register initialization logic module 206.

The PRS generation and partitioning logic module 200 also outputs the partition size Mₚ for each respective partition to its PRS generation logic module 212.

Generally speaking, each PRS bit is generated by taking XOR of selected previous bits. However, since XOR is an associative operation (i.e., (a XOR (b XOR c))=((a XOR b) XOR c)=((c XOR a) XOR b)), the final result does not depend on the order in which the XOR of the previous bits are taken. The method of the present invention makes use of the associative character of XOR operations.

Let:
\hat{x}₁=[\hat{x}₁ [30] \hat{x}₁ [29] . . . \hat{x}₁ [2] \hat{x}₁ [1] \hat{x}₁ [0]] and
\hat{x}₂=[\hat{x}₂ [30] \hat{x}₂ [29] . . . \hat{x}₂ [2] \hat{x}₂ [1] \hat{x}₂ [0]] denote 31- bit registers for PRS generation.

An arbitrary value of \hat{x}₁ at the n-th PRS generation step can be expressed as:

\hat{x}₁(n)=\hat{x}₁⁽³⁰⁾(n)XOR \hat{x}₁⁽²⁹⁾(n)XOR . . . XOR \hat{x}₁⁽²⁾(n)XOR \hat{x}₁⁽¹⁾(n)XOR \hat{x}₁⁽⁰⁾(n);

where \hat{x}₁^{(k)}(n)=(\hat{x}₁ (n)[k])qₖ, \hat{x}₁ (n)[k]∈{0,1}, and qₖ is a vector with the k-th element equal to 1 and all other elements equal to 0.

Similarly, an arbitrary value of 12 at the n-th PRS generation step can be expressed as:

\hat{x}₂(n)=\hat{x}₂⁽³⁰⁾(n)XOR \hat{x}₂⁽²⁹⁾(n)XOR . . . XOR \hat{x}₂⁽²⁾(n)XOR \hat{x}₂⁽¹⁾(n)XOR \hat{x}₂⁽⁰⁾(n);

where \hat{x}₂^{(k)}(n)=(\hat{x}₂ (n)[k])qₖ and \hat{x}₂ (n)[k]∈{0,1}.

Let f^{(L)}(⋅) represent taking L PRS generation steps on \hat{x}₁ and g^{(L)}(⋅) represent taking L PRS generation steps on \hat{x}₂. Since the XOR operation in PRS generation is associative, the values of \hat{x}₁ and \hat{x}₂ at the (n+L)-th PRS generation step can be expressed, respectively, as:

$${\hat{x}}_{1} ( n + L ) = {f}^{( L )} ( {\hat{x}}_{1} ( n ) ) = {f}^{( L )} ( {\hat{x}}_{1}^{( 30 )} ( n ) ) {XORf}^{( L )} ( {\hat{x}}_{1}^{( 29 )} ( n ) ) XOR … {XORf}^{( L )} ( {\hat{x}}_{1}^{( 2 )} ( n ) ) {XORf}^{( L )} ( {\hat{x}}_{1}^{( 1 )} ( n ) ) {XORf}^{( L )} ( {\hat{x}}_{1}^{( 0 )} ( n ) ) = ( {\hat{x}}_{1} ( n ) [ 30 ] ) {f}^{( L )} ( {q}_{30} ) XOR ( {\hat{x}}_{1} ( n ) [ 29 ] ) {f}^{( L )} ( {q}_{29} ) XOR … XOR ( {\hat{x}}_{1} ( n ) [ 2 ] ) {f}^{( L )} ( {q}_{2} ) XOR ( {\hat{x}}_{1} ( n ) [ k ] ) {f}^{( L )} ( {q}_{1} ) XOR ( {\hat{x}}_{1} ( n ) [ 0 ] ) {f}^{( L )} ( {q}_{0} ) ;$$

$$and$$

$${\hat{x}}_{2} ( n + L ) = {g}^{( L )} ( {\hat{x}}_{2} ( n ) ) = {g}^{( L )} ( {\hat{x}}_{2}^{( 30 )} ( n ) ) {XORg}^{( L )} ( {\hat{x}}_{2}^{( 29 )} ( n ) ) XOR … {XORg}^{( L )} ( {\hat{x}}_{2}^{( 2 )} ( n ) ) {XORg}^{( L )} ( {\hat{x}}_{2}^{( 1 )} ( n ) ) {XORg}^{( L )} ( {\hat{x}}_{2}^{( 0 )} ( n ) ) = ( {\hat{x}}_{2} ( n ) [ 30 ] ) {g}^{( L )} ( {q}_{30} ) XOR ( {\hat{x}}_{2} ( n ) [ 29 ] ) {g}^{( L )} ( {q}_{29} ) XOR … XOR ( {\hat{x}}_{2} ( n ) [ 2 ] ) {g}^{( L )} ( {q}_{2} ) XOR ( {\hat{x}}_{2} ( n ) [ 1 ] ) {g}^{( L )} ( {q}_{1} ) XOR ( {\hat{x}}_{2} ( n ) [ 0 ] ) {g}^{( L )} ( {q}_{0} ) .$$

Consequently, the values of \hat{x}₁ and \hat{x}₂ at the (n+L)-th PRS generation step can be determined from:
{\hat{x}₁ (n)[k]}ₖ₌₀³⁰, {f^{(L)}(qₖ)}ₖ₌₀³⁰; and
{\hat{x}₂ (n)[k]}ₖ₌₀³⁰, and {g^{(L)}(qₖ)}ₖ₌₀³⁰;
   where {\hat{x}₁ (n)[k]}ₖ₌₀³⁰ and ×2 (n)[k] k=0 are the values of \hat{x}₁ and \hat{x}₂ at the n-th PRS generation step.

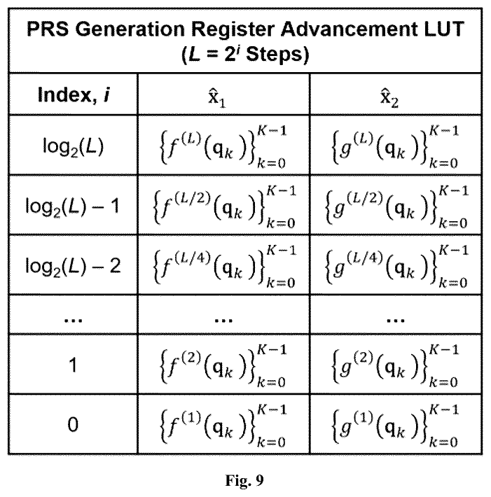

In accordance with the foregoing, FIG. 9 provides the LUT containing the pre-computed PRS generation register advancement values. These values can be pre-computed offline in a once only processing operation with the PRS generation register advancement values being stored in the LUT for easy retrieval in a real-time processing environment.

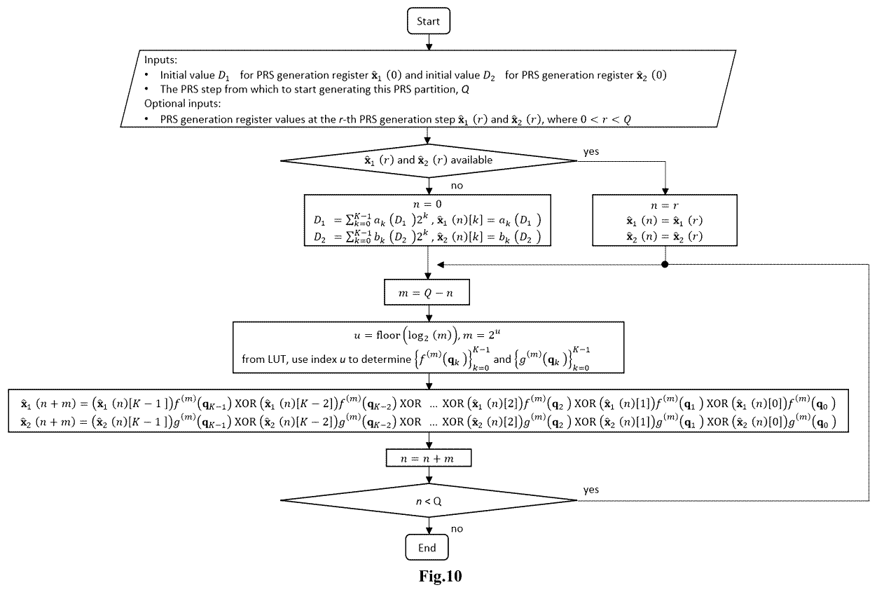

FIG. 10 provides a flow diagram of the progressive PRS generation register value calculation method performed by the progressive register value calculation module 214 of the PRS generation register initialization logic module 206. Advancing PRS generation to the Q-th step requires at most ceil (log₂(Q)) iterations, where each iteration requires 1 LUT search and XOR of 2*K K-bit registers. In this context:
log₂(X): Log base 2 value of X;
ceil(X): the smallest integer less than or equal to X; and
floor(X): The greatest integer less than or equal to X.

It can be seen from the foregoing that the improved method of the invention for a communications network such as a 5G communication network generates PRSs as M-sequence PRSs having a length M bits and given by c(n)=x₁(n+S) XOR x₂(n+S), where: n=0, . . . . M−1; S is an arbitrary offset value. The first long-term sequence x₁(n) follows a first generator function h₁(x₁(n−1), x₁(n−s), . . . x₁(n−K), x₁(n−(K−1)), D₁) to generate a newest bit by taking XOR of selected previous bits; the second long-term sequence x₂(n) follows a second generator function h₂(x₂(n−1), x₂(n−s), . . . x₂(n−K), x₂(n−(K−1), D₂) to generate a newest bit by taking XOR of selected previous bits; D₁=Σₖ₌₀^{K-1}x₁(k 2^{k} is the initial value of x₁; and D₂=Σₖ₌₀^{K-1}x₂ (k)2^{k} is the initial value of x₂.

The first generator function may be implemented by means of an XOR process and a bit shift of a first K-bit register comprising \hat{x}₁=[\hat{x}₁ [K−1] \hat{x}₁ [K−2] . . . \hat{x}₁ [2] \hat{x}₁ [1] \hat{x}₁ [0]] and the second generator function may be implemented by an XOR process and a bit shift of a second K-bit register comprising \hat{x}₂=[\hat{x}₂ [K−1] \hat{x}₂ [K−2] . . . \hat{x}₂ [2] \hat{x}₂ [1] \hat{x}₂ [0]], wherein calculating the first long-term sequence \hat{x}₁(n) is analogous to taking an n-th PRS generation step on the first K-bit register \hat{x}₁ whose value is expressed as \hat{x}₁ (n) and calculating the second long-term sequence x₂(n) is analogous to taking an n-th PRS generation step on second K-bit register \hat{x}₂ whose value is expressed as \hat{x}₂ (n).

The values of the first K-bit register \hat{x}₁ and the second K-bit register \hat{x}₂ at the m-th PRS generation step starting from initial values D₁ and D₂, respectively, may be determined as:

x₁(m)=(a_{K-1}(D₁))f^{(m)}(q_{K-1})XOR(a_{K-2}(D₁))f^{(m)}(q_{K-2})XOR . . . XOR(a₂(D₁))f^{(m)}(q₂)XOR(a₁(D₁))f^{(m)}(q₁)XOR(a₀(D₁))f^{(l)}(q₀)

and

x₂(m)=(b_{K-1}(D₂))g^{(m)}(q_{K-1})XOR(b_{K-2}(D₂))g^{(m)}(q_{K-2})XOR . . . XOR(b₂(D₂))g^{(m)}(q₂)XOR(b₂(D₂))g^{(m)}(q₂)XOR(b₀(D₂))g^{(m)}(q₀),

where {aₖ (D₁)}ₖ₌₀^{K-1} and {bₖ (D₂)}ₖ₌₀^{K-1}, aₖ (D₁)∈{0,1} and D₁=Σₖ₌₀^{K-1} aₖ (D₁)2^{k}, bₖ (D₂)∈{0,1} and D₂=Σₖ₌₀^{K-1} bₖ (D₂)2^{k}, f^{(m)}(qₖ) represents the value of \hat{x}₁ (m) given \hat{x}₁ (0)=qₖ, and g^{(m)}(qₖ) represents the value of \hat{x}₂ (m) given \hat{x}₂ (0)=qₖ.

The values of the first K-bit register \hat{x}₁ and the second K-bit register \hat{x}₂ at the (n+m)-th PRS generation step may be determined as:

$${\hat{x}}_{1} ( n + m ) = ( {\hat{x}}_{1} ( n ) [ K - 1 ] ) {f}^{( m )} ( {q}_{K - 1} ) XOR ( {\hat{x}}_{1} ( n ) [ K - 2 ] ) {f}^{( m )} ( {q}_{K - 2} ) XOR … XOR ( {\hat{x}}_{1} ( n ) [ 2 ] ) {f}^{( m )} ( {q}_{2} ) XOR ( {\hat{x}}_{1} ( n ) [ 1 ] ) {f}^{( m )} ( {q}_{1} ) XOR ( {\hat{x}}_{1} ( n ) [ 0 ] ) {f}^{( m )} ( {q}_{0} )$$

$$and$$

$${\hat{x}}_{2} ( n + m ) = ( {\hat{x}}_{2} ( n ) [ K - 1 ] ) {g}^{( m )} ( {q}_{K - 1} ) XOR ( {\hat{x}}_{2} ( n ) [ K - 2 ] ) {g}^{( m )} ( {q}_{K - 2} ) XOR … XOR ( {\hat{x}}_{2} ( n ) [ 2 ] ) {g}^{( m )} ( {q}_{2} ) XOR ( {\hat{x}}_{2} ( n ) [ 1 ] ) {g}^{( m )} ( {q}_{1} ) XOR ( {\hat{x}}_{2} ( n ) [ 0 ] ) {g}^{( m )} ( {q}_{0} ) ,$$

where {\hat{x}₁ (n)[k]}ₖ₌₀^{K-1} and {\hat{x}₂ (n)[k]}ₖ₌₀^{K-1}; \hat{x}₁ (n)[k]∈{0,1} and \hat{x}₂ (n)[k]∈{0,1}, are the values of the first K-bit register \hat{x}₁ and the second K-bit register \hat{x}₂ at the n-th PRS generation step; qₖ is a vector with the k-th element equal to 1 and all other elements equal to 0; f^{(m)}(qₖ) represents the value of \hat{x}₁ (m) given \hat{x}₁ (0)=qₖ; and g^{(m)}(qₖ) represents the value of \hat{x}₂ (m) given \hat{x}₂ (0)=qₖ.

The PRS generation register advancement values may comprise {f⁽¹⁾(qₖ)}ₖ₌₀^{K-1}, {f⁽²⁾(qₖ)}ₖ₌₀^{K-1}, . . . , {f^{(L/4)}(qₖ)}ₖ₌₀^{K-1}, {f^{(L/2)}(qₖ)}ₖ₌₀^{K-1}, {f^{(L)}(qₖ)}ₖ₌₀^{K-1}, {g⁽¹⁾(qₖ)}ₖ₌₀^{K-1}, {g⁽²⁾(qₖ)}ₖ₌₀^{K-1}, . . . , {g^{(L/4)}(qₖ)}ₖ₌₀^{K-1}, {g^{(L/2)}(qₖ)}ₖ₌₀^{K-1}, {g^{(L)}(qₖ)}ₖ₌₀^{K-1}, where f^{(m)}(qₖ) represents the value of \hat{x}₁ (m) given \hat{x}₁ (0)=qₖ, and g^{(m)}(qₖ) represents the value of \hat{x}₂ (m) given \hat{x}₂ (0)=qₖ, and wherein the PRS generation register advancement values are pre-computed and stored in an LUT in readiness for real-time generation of the PRS.

The PRS generation register advancement values are preferably pre-computed off-line and stored in the LUT for real-time retrieval.

Advancing the PRS generation from the n-th step to the m-th step is preferably performed progressively with intermediate steps using PRS generation register advancement values for 1, 2, . . . , L/4, L/2, L steps. The PRS generation may be advanced by any number of steps between 1 and 2*L−1.

Preferably, the M-sequence PRS having length M bits with initial values D₁ and D₂ is sub-divided into P partitions with lengths M₀, M₁, . . . , M_{P-1} bits and M=Σₚ₌₀^{P-1} Mₚ. The p-th PRS partition is preferably generated by starting with the initial values D₁ and D₂ and advancing by Σ_{q=0}^{p-1} M_{q} steps.

The p-th PRS partition with length Mₚ, cₚ=[cₚ (n+Mₚ−1), . . . , cₚ (n+1), cₚ (n)] can be split into an arbitrary number of W partitions as cₚ=[cₚ^{(W-1)} cₚ^{(W-2)} . . . cₚ⁽¹⁾ cₚ⁽⁰⁾].

Alternatively, the M-sequence PRS having length M bits generated as P partitions is concatenated from PRS partitions as c=c_{P-1} c_{P-2} . . . cₚ₊₁ cₚ cₚ₋₁ . . . c₁ c₀].

The invention also provides a communications network device having a processor a memory storing machine-readable instructions, wherein, when the machine-readable instructions are executed by the processor, they configure the communications network device to implement the method of any one of the appended method claims.

The radio equipment may comprise a gNodeB.

The invention also provides a non-transitory computer-readable medium storing machine-readable instructions, wherein, when the machine-readable instructions are executed by a processor, they configure the communications network device to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A computer implemented method of generating a pseudo random sequence (PRS), the method comprising:
sub-dividing PRS generation operations into a plurality of PRS partitions;
for each PRS partition, determining a PRS generation register value based on an initial PRS value and a pre-computed PRS generation register advancement value;
for each partition, using the determined PRS generation register value to generate a PRS of an arbitrary or a predetermined length; and
transmitting said generated PRS to a computing module, device or system to perform a data processing function.

2. The method of claim 1, wherein, prior to transmitting said generated PRS to a computing module, device or system, the method includes splitting a PRS partition and/or concatenating two or more PRS partitions to form the generated PRS to be transmitted to the computing module, device or system.

3. The method of claim 1, wherein the method uses a Linear Feedback Shift Register (LFSR) to generate a PRS of an arbitrary or a predetermined length.

4. The method of claim 1, wherein the PRS partitions are run across multiple parallel computing processes simultaneously or sequentially.

5. The method of claim 1, wherein the PRS generation operations to be partitioned into the plurality of partitions are based on a single long-term sequence or by XORing two or more long-term sequences.

6. The method of claim 1, wherein the PRS generation operations to be partitioned into the plurality of partitions are based on a first long-term sequence x₁(n) and a second long-term sequence x₂(n), the first long-term sequence x₁(n) having a first predefined initialization value and the second long-term sequence x₂(n) having a second predefined initialization value.

7. The method of claim 6, wherein the first predefined initialization value comprises an application specific initialization value and/or the second predefined initialization value comprises an application specific initialization value.

8. The method of claim 6, wherein the generated PRS is an M-sequence PRS having length M bits and is given by c(n)=x₁(n+S) XOR x₂(n+S), where: n=0, . . . M−1; S is an arbitrary offset value; the first long-term sequence x₁(n) follows a first generator function h₁(x₁(n−1), x₁(n−s), . . . x₁(n−K), x₁(n−(K−1)), D₁) to generate a newest bit by taking XOR of selected previous bits; the second long-term sequence x₂(n) follows a second generator function h₂(x₂(n−1), x₂(n−s), . . . x₂(n−K), x₂(n−(K−1)), D₂) to generate a newest bit by taking XOR of selected previous bits; D₁=Σₖ₌₀^{K-1} x₁ (k)2^{k} is the initial value of x₁; and D₂=Σₖ₌₀^{K-1} x₂ (k)2^{k} is the initial value of x₂.

9. The method of claim 8, wherein the first generator function is implemented by means of an XOR process and a bit shift of a first K-bit register comprising \hat{x}₁=[\hat{x}₁ [K−1] \hat{x}₁ [K−2] . . . \hat{x}₁ [2] \hat{x}₁ [1] \hat{x}₁ [0]] and the second generator function is implemented by an XOR process and a bit shift of a second K-bit register comprising \hat{x}₂=[\hat{x}₂ [K−1] \hat{x}₂ [K−2] . . . \hat{x}₂ [2] \hat{x}₂ [1] \hat{x}₂ [0]], wherein calculating the first long-term sequence x₁(n) is analogous to taking an n-th PRS generation step on the first K-bit register \hat{x}₁ whose value is expressed as \hat{x}₁ (n) and calculating the second long-term sequence x₂(n) is analogous to taking an n-th PRS generation step on second K-bit register \hat{x}₂ whose value is expressed as \hat{x}₂ (n).

10. The method of claim 9, wherein the values of the first K-bit register \hat{x}₁ and the second K-bit register \hat{x}₂ at the m-th PRS generation step starting from initial values D₁ and D₂, respectively, are determined as:
$${\hat{x}}_{1} ( m ) = ( {a}_{K - 1} ( {D}_{1} ) ) {f}^{( m )} ( {q}_{K - 1} ) XOR ( {a}_{K - 2} ( {D}_{1} ) ) {f}^{( m )} ( {q}_{K - 2} ) XOR … XOR ( {a}_{2} ( {D}_{1} ) ) {f}^{( m )} ( {q}_{2} ) XOR ( {a}_{1} ( {D}_{1} ) ) {f}^{( m )} ( {q}_{1} ) XOR ( {a}_{0} ( {D}_{1} ) ) {f}^{( l )} ( {q}_{0} )$$
$$and$$
$${\hat{x}}_{2} ( m ) = ( {b}_{K - 1} ( {D}_{2} ) ) {g}^{( m )} ( {q}_{K - 1} ) XOR ( {b}_{K - 2} ( {D}_{2} ) ) {g}^{( m )} ( {q}_{K - 2} ) XOR … XOR ( {b}_{2} ( {D}_{2} ) ) {g}^{( m )} ( {q}_{2} ) XOR ( {b}_{1} ( {D}_{2} ) ) {g}^{( m )} ( {q}_{1} ) XOR ( {b}_{0} ( {D}_{2} ) ) {g}^{( m )} ( {q}_{0} ) ,$$
where {aₖ (D₁)}ₖ₌₀^{K-1} and {bₖ (D₂)}ₖ₌₀^{K-1}, aₖ (D₁)∈{0,1} and D₁=Σₖ₌₀^{K-1} aₖ (D₁)2^{k}, bₖ (D₂)∈{0,1} and D₂=Σₖ₌₀^{K-1} bₖ (D₂)2^{k}, f^{(m)}(qₖ) represents the value of \hat{x}₁ (m) given \hat{x}₁ (0)=qₖ, and g^{(m)}(qₖ) represents the value of \hat{x}₂ (m) given \hat{x}₂ (0)=qₖ.

11. The method of claim 9, wherein the values of the first K-bit register \hat{x}₁ and the second K-bit register \hat{x}₂ at the (n+m)-th PRS generation step are determined as:
$${\hat{x}}_{1} ( n + m ) = ( {\hat{x}}_{1} ( n ) [ K - 1 ] ) {f}^{( m )} ( {q}_{K - 1} ) XOR ( {\hat{x}}_{1} ( n ) [ K - 2 ] ) {f}^{( m )} ( {q}_{K - 2} ) XOR … XOR ( {\hat{x}}_{1} ( n ) [ 2 ] ) {f}^{( m )} ( {q}_{2} ) XOR ( {\hat{x}}_{1} ( n ) [ 1 ] ) {f}^{( m )} ( {q}_{1} ) XOR ( {\hat{x}}_{1} ( n ) [ 0 ] ) {f}^{( m )} ( {q}_{0} )$$
$$and$$
$${\hat{x}}_{2} ( n + m ) = ( {\hat{x}}_{2} ( n ) [ K - 1 ] ) {g}^{( m )} ( {q}_{K - 1} ) XOR ( {\hat{x}}_{2} ( n ) [ K - 2 ] ) {g}^{( m )} ( {q}_{K - 2} ) XOR … XOR ( {\hat{x}}_{2} ( n ) [ 2 ] ) {g}^{( m )} ( {q}_{2} ) XOR ( {\hat{x}}_{2} ( n ) [ 1 ] ) {g}^{( m )} ( {q}_{1} ) XOR ( {\hat{x}}_{2} ( n ) [ 0 ] ) {g}^{( m )} ( {q}_{0} ) ,$$
where {\hat{x}₁ (n)[k]}ₖ₌₀^{K-1} and {\hat{x}₂ (n)[k]}ₖ₌₀^{K-1}; \hat{x}₁ (n)[k]∈{0,1} and \hat{x}₂ (n)[k]∈{0,1}, are the values of the first K-bit register \hat{x}₁ and the second K-bit register \hat{x}₂ at the n-th PRS generation step; qₖ is a vector with the k-th element equal to 1 and all other elements equal to 0; f^{(m)}(qₖ) represents the value of \hat{x}₁ (m) given \hat{x}₁ (0)=qₖ; and g^{(m)}(qₖ) represents the value of \hat{x}₂ (m) given \hat{x}₂ (0)=qₖ.

12. The method of claim 9, wherein the PRS generation register advancement values comprise {f⁽¹⁾(qₖ)}ₖ₌₀^{K-1}, {f⁽²⁾(qₖ)}ₖ₌₀^{K-1}, . . . , {f^{(L/4)}(qₖ)}ₖ₌₀^{K-1}, {f^{(L/2)}(qₖ)}ₖ₌₀^{K-1}, {f^{(L)}(qₖ)}ₖ₌₀^{K-1}, {g⁽¹⁾(qₖ)}ₖ₌₀^{K-1}, {g⁽²⁾(qₖ)}ₖ₌₀^{K-1}, . . . , {g^{(L/4)}(qₖ)}ₖ₌₀^{K-1}, {g^{(L/2)}(qₖ)}ₖ₌₀^{K-1}, {g^{(L)}(qₖ)}ₖ₌₀^{K-1}, where f^{(m)}(qₖ) represents the value of \hat{x}₁ (m) given \hat{x}₁ (0)=qₖ, and g^{(m)}(qₖ) represents the value of \hat{x}₂ (m) given \hat{x}₂ (0)=qₖ, with the PRS generation register advancement values being pre-computed and stored in a lookup table in readiness for real-time generation of the PRS.

13. The method of claim 12, wherein advancing PRS generation from the n-th step to the m-th step is performed progressively with intermediate steps using PRS generation register advancement values for 1, 2, . . . , L/4, L/2, L steps.

14. The method of claim 13, wherein PRS generation is advanced by any number of steps between 1 and 2*L−1.

15. The method of claim 7, wherein the M-sequence PRS having length M bits with initial values D₁ and D₂ is sub-divided into P partitions with lengths M₀, M₁, . . . , M_{P-1} bits and M=Σₚ₌₀^{P-1} Mₚ.

16. The method of claim 15, wherein the p-th PRS partition is generated by starting with initial values D₁ and D₂ and advancing by Σ_{q=0}^{p-1} M_{q} steps.

17. The method of claim 7, wherein the p-th PRS partition with length Mₚ, cₚ=[cₚ (n+Mₚ−1), . . . , cₚ (n+1), cₚ (n)] is split into an arbitrary number of W partitions as cₚ=[cₚ^{(W-1)} cₚ^{(W-2)} . . . cₚ⁽¹⁾ cₚ⁽⁰⁾].

18. The method of claim 7, wherein the M-sequence PRS having length M bits generated as P partitions is concatenated from PRS partitions as c=[c_{P-1} c_{P-2} . . . cₚ₊₁ cₚ cₚ₋₁ . . . c₁ c₀].

19. A device in a communications network, the device comprising:
a memory storing machine-readable instructions; and
a processor for executing the machine-readable instructions such that, when the processor executes the machine-readable instructions, it configures the communications device to:
generate a pseudo random sequence (PRS) by:
sub-dividing PRS generation operations into a plurality of PRS partitions;
for each PRS partition, determining a PRS generation register value based on an initial PRS value and a pre-computed PRS generation register advancement value;
for each partition, using the determined PRS generation register value to generate a PRS of an arbitrary or a predetermined length; and
transmitting said generated PRS to a computing module, device or system to perform a data processing function.

20. A non-transitory computer readable medium comprising machine-readable instructions which, when executed by a processor of a communications network device, causes the communications network device to implement the steps of:
sub-divide PRS generation operations into a plurality of PRS partitions;
for each PRS partition, determine a PRS generation register value based on an initial PRS value and a pre-computed PRS generation register advancement value;
for each partition, use the determined PRS generation register value to generate a PRS of an arbitrary or a predetermined length; and
transmit said generated PRS to a computing module, device or system to perform a data processing function.

21. The method of claim 10, wherein the PRS generation register advancement values comprise {f⁽¹⁾(qₖ)}ₖ₌₀^{K-1}, {f⁽²⁾(qₖ)}ₖ₌₀^{K-1}, . . . , {f^{(L/4)}(qₖ)}ₖ₌₀^{K-1}, {f^{(L/2)}(qₖ)}ₖ₌₀^{K-1}, {f^{(L)}(qₖ)}ₖ₌₀^{K-1}, {g⁽¹⁾(qₖ)}ₖ₌₀^{K-1}, {g⁽²⁾(qₖ)}ₖ₌₀^{K-1}, . . . , {g^{(L/4)}(qₖ)}ₖ₌₀^{K-1}, {g^{(L/2)}(qₖ)}ₖ₌₀^{K-1}, {g^{(L)}(qₖ)}ₖ₌₀^{K-1}, where f^{(m)}(qₖ) represents the value of \hat{x}₁ (m) given \hat{x}₁ (0)=qₖ, and g^{(m)}(qₖ) represents the value of \hat{x}₁ (m) given \hat{x}₁ (0)=qₖ, and g^{(m)}(qₖ) represents the value of \hat{x}₂ (m) given \hat{x}₂ (0)=qₖ, with the PRS generation register advancement values being pre-computed and stored in a lookup table in readiness for real-time generation of the PRS.
